(19) United States
(12) Patent Application Publication
(10) Pub. No.: US 2005/0280706 A1
(43) Pub. Date: Dec. 22, 2005

(54) Method and apparatus to simulate an outdoor window for panorama viewing from a room

(75) Inventor: Chiou-muh Jong, Ellicott City, MD (US)

Correspondence Address: CHIOU-MUH JONG, 11058 DORCH FARM ROAD, ELLICOTT CITY, MD, 21042, US

(73) Assignee: Chiou-muh Jong, Ellicott City, MD (US)

(21) Appl. No.: 11/161,476

(22) Filed: Aug. 4, 2005

Related U.S. Application Data
(60) Provisional application No. 60/522,176, filed on Aug. 25, 2004.

(51) Int. Cl. H04N 7/18

(52) U.S. Cl. 348/143; 348/36

(57) ABSTRACT

A method and system to bring panorama views for displaying in multiple rooms, especially windowless rooms are shown in present invention. The display unit installed in each room not only used as a display screen for quasi live panoramic views from all corners around the whole world, but also equipped with real window covering or controllable artificial window covering such that the unit itself looks and functions like a real outdoor visible window with window covering. While the version implemented with real window covering operated synchronously with operation of the display screen, the version implemented with artificial window covering offers more choices that the window covering on display is replaceable and can also be controlled like a real one. These apparatus not only can be used to display quasi real-time outdoor scene, but also can be used to display other video images and serves as a decoration item for a windowless room particularly in a hotel or panorama sensitive building wherein a good view is important.

### 1. CROSS-REFERENCE INFORMATION

The present application is an extension to the co-pending U.S. patent application Ser. No. 10/604709 filed on Aug. 12, 2003 entitled as “Method and apparatus to simulate an outdoor window for a windowless room”. The present application also claims the priority to co-pending U.S. Provision patent application Ser. No. 60/522176 entitled “Method and apparatus to simulate an outdoor window for panorama viewing from a room” filed on Aug. 27, 2004.

### 2. FIELD OF THE INVENTION

The present invention relates to the simulation of outdoor windows for displaying dynamic panorama from multiple desired locations along with real window coverings or manipulatable window covering images. It relates to the application of a surveillance system as well.

### 3. BACKGROUND

Recent advances in display monitor technologies such as liquid crystal display (LCD), organic light emitting diode (OLED) and plasma displays have been obvious. It is easy to notice that the screens for televisions and personal computers have gradually become flat and getting bigger in size. In fact, they are not only getting bigger in display size, but also weighing lighter and getting more affordable in the commercial market. As the advance of such display technology is going on, the big, flat and light in weight display screens will have more interesting applications. For example, one ideal application for these big, flat display monitors is to use them to simulate the outdoor window for a windowless room. Anybody who works in a commercial office building knows that rooms with windows to see outdoor scene are always in great demands, and such outdoor scene accessible rooms are usually assigned only to those employees who hold higher positions. Furthermore, the simulated outdoor window system is an excellent tool for viewing the panorama of desired location. It is well known that the prices of many private condos or other housing units, especially those in the vicinities of inner harbors in big cities, are very sensitive to “good view”. Typically if the floor of the rooms in a big building is higher and facing to the direction of “good view”, then the views from such rooms are better and consequently the prices for such condos are relatively higher. Therefore, a simulated outdoor window which can display dynamic panorama with background sound of desired location definitely will be an excellent tool to get “good view” for those units without “good view” and consequently can match up closer in unit prices to those condos with access to “good view”.

Actually, even those condos with “good views” can also benefit from current invention. With the broadband Internet getting more popular and the advance in the “wireless” technology, it is really easy to bring the dynamic views from any location in any city in the world to the simulated window. So those condos with “good view” can also have a simulated outdoor window to display “good views” from locations of other cities, even in other countries.

As another application, it is obvious to see that hotel rooms can be benefited from present invention. Hotel rooms are sensitive to good views too. With current invention, the inner rooms without window can have “good views” by installing one embodiment of current invention to get “good view”. Consequently, with such simulated outdoor window available from current invention, the hotel construction can lead to a radical change in that the inner rooms without real outdoor windows will no more be avoided. Since most hotel rooms are equipped with television set, the display screen used in current invention can also be used to display TV and other entertainment programs, so it is multifunctional display.

In the mean time, the surveillance systems for monitoring specific locations are getting more popularity. Such system often equipped with at least a wireless video camera to obtain the dynamic image sequence from the surveyed locations. With the maturity of such kind technology, it is natural and of no difficulty to add function which will interactively create the image of window covering such as mini-blind according to user's input and superimpose the created image into the images displaying in such surveillance system, resulted to a simulated window system which looks like a real window with curtain and outdoor scene on display. Alternatively, we can mount the screen of the surveillance system on the wall in a windowless room, install the video camera at a outdoor location then put a real curtain or mini-blinds on the top of the display screen to have one form of the simulation of outdoor window with real curtain. For simulation purpose, the activation of display function of the monitor should be in synchronized with the movement of the real curtain. However, there will be no plurality of types and styles of the curtains in such arrangement and sometimes it is not easy to install particular style of curtains, blinds or the shades, and once installed, it is difficult to replace to another one. Cost of window coverings is another factor for consideration.

While the commercial surveillance systems are used for monitoring scenes of interest for security or other reasons, most emphasis in designing such systems is in the motion detection from the clues reveal in the image sequence. The purpose of present invention, on the other hand, is to provide dynamic views from interested outdoor locations using display monitors with manipulatable curtain image that looks similar to an outdoor scene accessible window with real curtain. It is fair to say that, in addition to its functional value, the present invention also has great decoration value by mounting a beautiful simulated window on the wall.

Attempts already existed in trying to simulate a real window, U.S. Pat. No. 5,251,392 for example, attempted to invent an artificial window without using a display monitor. It's purpose, unlike present invention, is solely to create an apparatus, which looks like a real window without being able to see outside scene. A more closer invention relates to this one is U.S. Pat. No. 6,140,565, in which Yamauchi, et al. disclosed a way to synthesize visual image of the music system and showed the way to create a performance situation images having open curtain. In addition, they also disclosed using sequence of images, although it is not live but stored in memory, for synthesizing of performance scene. However, there are crucial differences between current invention and the one by Yamauchi, et al. In current invention, each outside scene images is pre-segmented to partial image using the information of viewer's movement as criteria for segmentation. Also, the details in creating images of various curtain styles and curtain positions and the concept to manipulate the reconstructions of these images for simulating functions of real window coverings were not existed in the invention by Yamauchi, et al. In other words, they didn't have the idea to construct window covering images leaf by leaf, pleat by pleat, and control them using user interface followed by reconstruction of instant simulation images. In addition, the concept of sources of outdoor images come from all corners of the world as well as local good views and outdoor scene in present invention is totally new idea never existed in the invention by Yamauchi, et al.

One feature of present invention is that the monitor mounted on the wall can also be used as computer monitor or as other display device, provided that the monitor has imbedded a selection switch to select to select from at least two modes of applications, one for simulation and another for TV or computer monitor. Multi-purpose monitors have become easier to implement because the increasing popularity of digital TV programs which are displayed in either plasma or LCD monitors—both accept digital signals just like computer monitors. There is no question that the trend in the near future is to use digital signals for better video quality. We have already seen this happens in TV cellular phone industries.

Recent development in Wireless technology such as Bluetooth has made short distance wireless applications very convenient to implement. By using such technology in receiving the outdoor images, the resulted window simulation system will be portable to mount on any wall where power is available. Bluetooth can also be applied to the wireless communication between wall mounted monitor and computer such that operations on desktop keyboard/mouse can remotely control the display on the monitor.

There is no question that one who is familiar with the art of developing computer software for creating images can design software dedicated to creating the instant simulation images. But one should know that when the display screen is mounted on the wall as a requirement in present invention, it is difficult to hide the connection cable between computer and display monitor, so a wireless communication between them would be assumed. Therefore, an extra cost already exists by using computer to process the simulation images. In fact, a standalone embodiment of present invention offers many more advantages over embodiment that uses computer power and memory to achieve the simulation. First, not every windowless room has a computer. Standalone design makes it portable to every windowless room. Second, the simulation process in present invention does not need as much computing power and storage memory as a typical personal computer, so it is good to have simpler CPU and memory to independently process the images. Personal computers usually take more than 30 seconds to boot up. It would be too tedious if one needs to start a computer before starting the window simulation every time unless the computer stays in running mode all day long. Third, using computer keyboard/mouse to move curtain up and down does not offer as good in simulation fidelity as using the user interface devices installed directly around the rim of the display screen.

### 4. SUMMARY OF THE INVENTION

A method and system to provide simulated windows for display the panorama views from multiple locations is presented. According to one aspect of present invention, users of one embodiment of this invention will be able to see the outdoor scene from desired locations in a room with the choice of their favorite window coverings simulated on the screen, manipulate the simulated window coverings at their desired openings and positions. The users can also hear the background sound coming from scene location. As such, the resulted embodiment of this invention is not only useful as a tool for providing a quasi-real feeling of viewing the panorama in the rooms of hotels or some private condos in a high rise building where the prices are sensitive to good views, but also a good decoration item for such rooms to install.

### 5. BRIEF DESCRIPTION OF DRAWINGS

FIG. 1 shows one typical room partitions for one floor in a building. It illustrates that some rooms have access to particular views and some inner rooms have no views at all.

FIG. 2 shows 4 local configurations of cameras at various locations representing various panorama views from same local area and monitors for displaying the views and controllable window covering images.

FIG. 3 shows an embodiment of an outdoor window simulation system with a half opened, mid-positioned mini-blind in display.

FIG. 4 is a block diagram showing the steps in creating instant simulation images.

FIG. 5 shows that the segmentation of each frame of the sequence of outdoor scene images according to the viewer's position relative to the display monitor and movement detected by the motion detector.

### 6. DETAILED DESCRIPTION

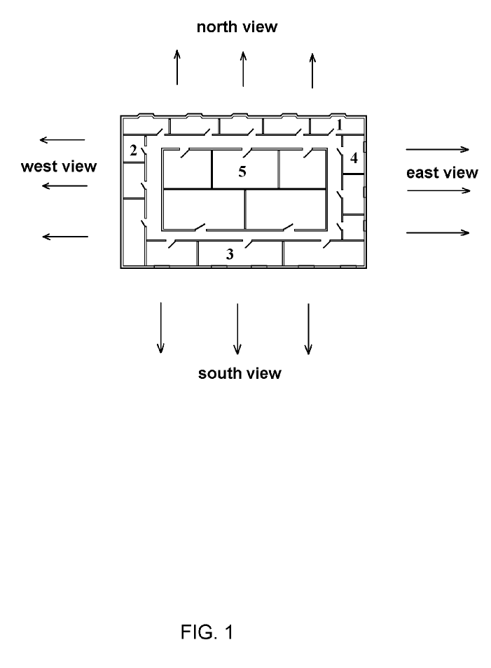

FIG. 1 shows a big building, a big hotel in particular, partitioned into many rooms. Some rooms, room 1 for example, have a window facing north direction and thus a north view is available. Similarly, room 2, room 3 and room 4 have west, south and east views respectively, while the inner room 5 has no view at all. Suppose that north view is a ocean view and is considered as the most desirable one among the four available views, this particular view is not only desirable for inner room 5, it is desirable for rooms 2, 3 and 4 as well, if there is a way to get it. Further more, if the elevation of the floor shown in FIG. 1 is not high enough, other buildings can still block the views from rooms facing north direction, thus an artificial outdoor window that can be used to dynamically display the good ocean view is still very desirable.

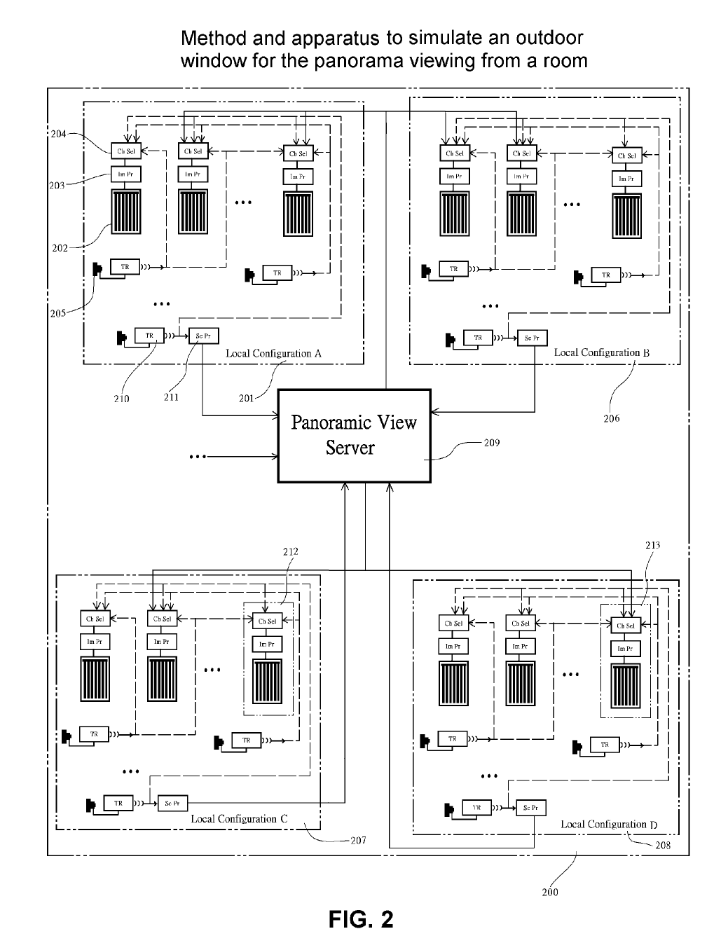

In FIG. 2, four of many possible configurations for the arrangement of the connections between cameras such as 205 and display monitors such as 202 used as panoramic view displays in the same local area. A unit of artificial panorama viewing system embodied in current invention will include the display monitor 202, image processor 203 and panoramic view channel selector 204, although 203 and 204 may physically imbedded inside 202. Channel selector functions as a receiver to accept sequences of outdoor scene images coming either directly from local transmitter such as 210, and functions as a client, accepting sequences of outdoor scene images through the data network such as Internet provided by the panoramic view server(s), which collects the panoramic views from the outdoor scene providers such as 211. The combination of outdoor scene provider with associated camera/transmitters could spread around the world where good views exist.

A typical simulation unit, whether it is a SWPWRC (simulation window paired with real curtain) or a SWPWAC (simulation window paired with artificial curtain), can all have it's own connections based on user's needs. The unit 212, for example, has no remote connection, it's panorama views channel selector only has channels connected to local sources of outdoor scene images. The unit 213, on the other hand, has both local connections and Internet connections from panoramic view server 209.

A complete system implements current invention will typically include much more than 4 local configurations shown in 200 in FIG. 2. Local configuration such as 201, 206,207 and 208 may only represent the local connections available for a building with a lot of rooms, such as a hotel. In such case, 4 different views may be enough and all simulation units (SWPWRC and SWPWAC) will have at least one view connection from them. In the case where there is a cluster of condominium, it may represent the region of the condominium community in which there is no good view at all, consequently the connections may only exist as network connections.

Since there are too many locations around the world for the sources of good views, obviously too many candidates are available for cameras to be installed as the sources of panoramic view images. Therefore, depends on the capacity of the panorama view server and number of servers, only a limit number of locations can be selected as locations to provide panorama views for the network connections in current invention.

Subject to the limit of network transmission speed and capacity of the server, the images in sequence can be compressed before uploading to the network and uncompressed later in the server. The server can also execute the image segmentation process for every frame based on the information fed from each panorama view channel selector, which in turn gathering from motion detector sensing the motion of a viewer, thus transmit only the partial sequence of images to each panorama view channel selector.

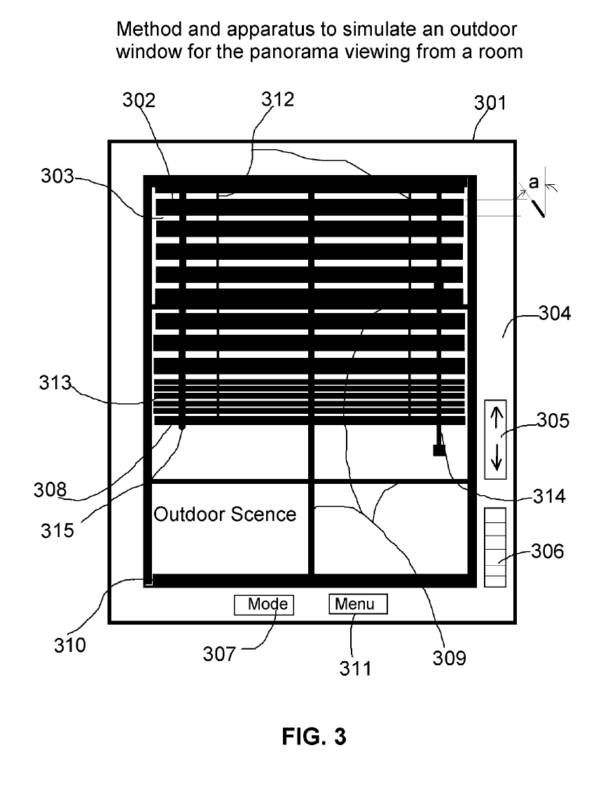

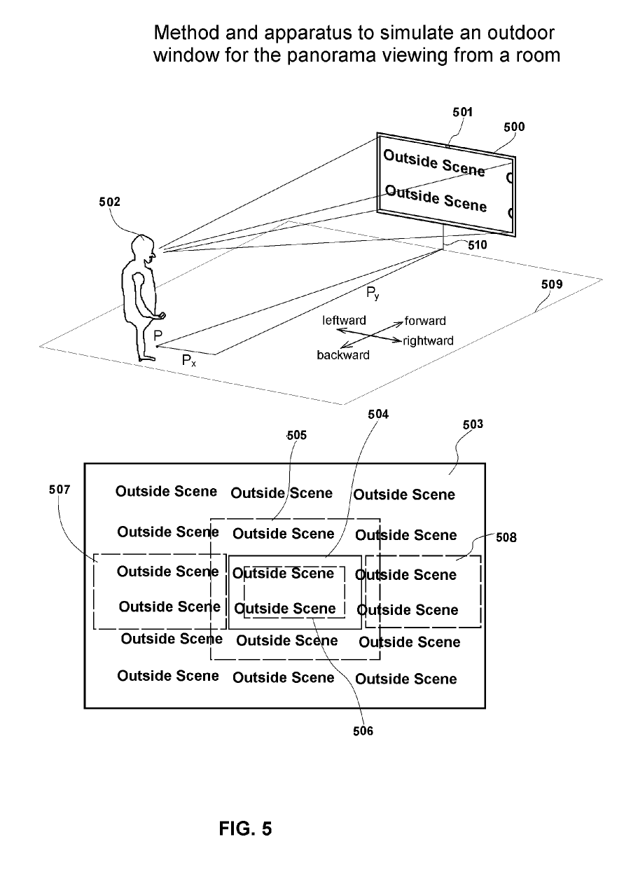

The outdoor images, as well as the window image and window covering image, will all be processed in the image processor. As shown in details in FIG. 3, the image processor creates fixed window image based on the user's choice of type of window structure and then creates a window covering image based on user's choices of type, style and color and current settings of openness and position of the window covering before combining them into a static image. This image is static in the sense that it will stay the same until user inputs new openness or new position through interface devices and consequently forces the image processor to redraw the static image. The image processor further combines the static image with current available image from the receiver into instant simulation image based on the viewer's movement detected by motion detector 501 shown in FIG. 5 and sends to the display monitor at a typical display rate of 30 frames per second.

If the fixed window image and window covering image are considered as coming from two separated channels, then the image processor can be viewed as a special purpose three input one output multiplexer. While the function of a typical multiplexer is to combine the images from different locations into one display, or to perform some image processing in order to extract some clues for motion detection, the function of the image processor in present invention is to overwrite portions of the outdoor image by the contents in the static image. In most applications, the multiplexer is designed and built as a stand alone device and uses wires to connect to other devices. The preferable embodiment of present invention is to install the hardware of the image processor into the display monitor for considerations of portability and fidelity of simulation.

FIG. 3 illustrates a more detailed embodiment of present invention. In this particular embodiment, an outdoor window with edges 310 at all four rims and a window grid 309 consists of three grid members for separating the window into six equal portions is shown. Also shown in FIG. 3 is the example of using mini-blind as the window covering. The mini-blind has an openness angle a with respect to the vertical line shown in the drawing at the first leaf 302. The gap 303 between two leafs disappears when user adjusts the openness angle a of all leafs to 90 degree and consequently the window portion from top to the position of the end piece 308 will be fully blinded, as a real mini-blind does to a real window. Note that unless the end piece is moved to the full extension position, some of the bottom leaves 313 will remain unexpanded and have an openness angle of 90 degree. The openness angle is adjusted through the user interface device 306, which functions like a wand tilter in a real mini-blind. The device 306 can be of any kind analog switch. Shown in the drawing is a particular embodiment using turn-wheel type switch to adjust the openness angle.

27 Also in FIG. 3, the display monitor 301 has an outer frame 304, which hosts another user interface devices 305. Interface device 305 is an increment-decrement type of analog input device, functions like a lifting cord in a real mini-blind, for the user to move the position of end piece 308 of the mini-blind up and down. This interface device is universally useful to all types, styles of window coverings. For the case of a vertical blind, the position of the blind is characterized by the side piece if the operation is to move all the leafs sideward, or by the center piece of the blind if the operation is to split in the center by moving half of the leaves leftward and another half rightward.

The Mode switch 307 is used to set the application mode to be simulation mode, TV mode if the monitor itself is a television set, normal display mode as computer monitor or as other video display application.

It is obvious that, for the outdoor window simulation system to be more portable, the receiver, the memory storage for window structure and window covering information, and image processor are preferred to be imbedded inside the display monitor. The memory storage in particular, can be merged with the memory in monitor such that the display for selection of a particular window structure and window covering type, style, and color is integrated with the menu built in the monitor. The selections user makes in this setup stage are stored as default values and will be used when the power is on, staying the same until user change them. User should also be allowed to change the window structure and window covering settings at run-time during the instant simulation image is on display. The interface device 311 is used to serve for this purpose. Functionally, when the pushbutton device as an example of device 311 is pushed, a small popup will display all possible choices for the user. A touch-screen control will be appropriate in this case for user to select and highlight the desired item. Another push on the button will terminate the selection process and resume the instant simulation image with new selection of window covering or new look of the window structure.

The remote control device used for a television set is another place to imbed all the user interfaces and controls for simulation. One embodiment of present invention is to use a television set as the display monitor, the remote controller is usually available for the TV set and can be reprogrammed such that the setup menu also include the selection of window structures and selection of window covering types, styles and colors, provided that the necessary memory storage and control circuit have also installed and integrated with other circuit inside the TV set.

In the process of creating instant simulation image, any pixel location where it does not belong to window edges, window grid and window covering, should get it's pixel value from outdoor image. The gap 303 in FIG. 3, for example, should reveal a small portion of the outdoor image, otherwise the simulation will not look real and thus loses some fidelity.

The static image is a combination of fixed window image and the window covering image. Fixed window image is relatively simple since the image will not change through the all display time, so the whole image can be pre-constructed and stored in the memory waiting for retrieval. Some windows installed in the big building are not operable, have no edges, no window grids at all. Smaller operable window typically has upper and bottom halves, and each half has several grid members to separate it into 2, 4, 6 or 9 equal regions. In fact, the window structure is simple enough to be constructed by using only some parameters which represent the location coordinates of vertices of all edges, location coordinates of grid members, and their colors to reconstruct the fixed window images.

By comparison, the window covering image is much more involved. A shade, for example, is a piece of cloth or other material folded to have many wavy pleats and sandwiched by a top piece and an end piece wood like strips. There are no leaves, so there is no leave angle to adjust. It shelters the window from the top to the end piece and the only adjustment user can manipulate is its position. This is an example of window covering with only one degree of freedom. In order to reconstruct the image of a shade extended to a particular position, one can digitize the entire stroke of the position of the end piece into N steps. N should be large enough so that when end piece is moved from position i to i+1, where i+1<=N, the transition in image change should look as smooth as possible. The pleats will be stretched flatter when the end piece is moved to extend the shade, so every position i corresponds to a width w of all pleats. Because all pleats are of same size w, a total of n such size pleats connected together plus top and end pieces represent the completed shade being extended to position i. The entire shade is hold together in place by two thin ropes 312. To reconstruct the image for the entire shade extended to position i, all we need is the graphics of top and end pieces, the graphic of a pleat with width w. In other words, if in the memory we have stored graphics of top and end pieces and graphics of N pleats of distinct widths, we can reconstruct shade images for all N positions. When a user moves the increment/decrement input device starting at shade position i and finally stopping at position j, the image processor will retrieve the graphic for the pleat at each intermediate position and copy it to get a total of n pleats of the same size, combines them with top and end pieces to form a intermediate shade image, and continue to process the same way until the shade image at position j is reached. For better simulation fidelity, each graphic can have 3-D or animation effect. Each graphic of the pleat should also include small sections of the two thin ropes such that, when n graphics of the same pleats are combined together, the two thin ropes will look like extending from top piece to end piece without interruptions.

For other type window coverings with two degrees of freedom, such as a mini-blind, has both openness and position to adjust and consequently the modeling situation is different. The operation of a mini-blind is characterized by changing the leaves openness angle using a wand tilter and by expanding a number of leaves from it's total amount using the lift cord. Therefore, in this particular embodiment, N graphics of the leaves representing N openness angles are stored, along with graphics of the top and end pieces and other necessary information such as color of leaves. To reconstruct the image of a mini-blind at an openness angle a and an extended position p with the understanding that position p corresponds to m expanded and n−m unexpanded leaves of total number n, the image process will retrieve the graphic of leaf corresponding to openness angle a, duplicates it m−1 times to make m graphics of openness angle a, then combines them together to form the expanded portion of the mini-blind image. Image processor will also retrieve the graphic of leaf corresponding to openness angle of zero degree, duplicates n−m−1 times, combines them together to form the unexpanded portion of the mini-blind image. Top piece and end piece are then added to complete the entire mini-blind image. During the combination of m leaves for the expanded portion of the blind image, a gap of amount g which depends on the openness angle will be added between blind leaves and the pixel values of these gaps will be replaced later by pixel values from same locations in the outdoor image when the instant simulation image is reconstructed. The image reconstruction process will be repeated every time when the user operates the interface 305 to move blind up and down or interface 306 to change the leaves openness of the blind.

Alternatively, if the memory size is big enough, one can use a digital camera, take the pictures of a real shade extended at N different positions, manually edits all pixels not belong to the shade with a special pixel value uniformly and then store them as shade image templates for retrieval. When a static image is required, the image processor retrieves fixed window image and the shade image template corresponding to desired position, combines them together, with the understanding that whenever a pixel is overlapped from both images, the shade image pixel will be used as new pixel value. In such way, the static image for desired window structure and shade can be created. In creating instant simulation image we note that all the pixels in static image with uniform special value will be replaced by pixel values of the outdoor image at same locations. So for window coverings of one degree of freedom, we can reconstruct the static image in similar way. For two degrees of freedom window coverings such as a vertical blind, it is difficult to store all images for every digitized openness angle and every digitized position, because if 100 positions and 90 angles are used, there will be 9,000 images to be stored and roughly 9 gigabyte memory is needed even if the resolution of each image is as low as 1 megapixels. It will then be possible for this embodiment without a big storage memory if a suitable image compression method is available without losing too much of the image quality when used. Otherwise, a scheme to reduce the number of images stored is necessary. Actually, one needs only to store the images for all digitized openness angles as image templates and then reconstruct the images for all positions based on these templates. Every image template is a digital picture taken at a specific openness angle, preferably with only one leaf expanded and the rest unexpanded. When a vertical-blind image of desired position and specific openness angle is needed, the template corresponding to desired angle is retrieved. Based on the desired position, some number of expanded leaves will be and the same amount of the unexpanded leaves will be reduced to match the desired position. Unfortunately, this way of reconstructing image for window covering of two degrees of freedom does not improve much as compared to the total reconstruction method mentioned in previous paragraph. If the memory size not a problem and good image compression scheme is available, it is a better implementation to store images for all digitized positions and all digitized openness angles for retrieval.

The size of display monitor for present invention depends on the size of the room to install the system, but there is no strict rule to follow. Currently, the largest commercially available size for plasma monitors such as NEC PlasmaSync 61MP by NEC Corporation of Japan is 61″ diagonally and has aspect ratio of 16:9, which is roughly 53″×30″ in length by width. With such size display monitor, it should be big enough for most windowless room to display a simulated outdoor scene with operable artificial curtain. Largest size for commercially available LCD monitors is 40″ diagonally, also by NEC with model name LCD4000, translates into 34″×20″, is bigger than many small real windows, therefore should be big enough for many small rooms. For the purpose of application in present invention, the sizes of available monitors are thus not a problem. The thickness of the monitors is thinner than 4″ for largest plasma monitor, which is thin enough to look like a real window mounting on the wall. The weight of monitor, around 150 pounds for largest plasma monitor, is light enough not to cause too much trouble mounting on the wall. The only concern is the price of big size display monitors. However, as happened to all other electronic products, the price will drop sharply as the popularity of digital TV increases to some point.

The frame 304 in FIG. 3 can be framed with a wood molding for better look and more similar to a real window. Normally, a mini-blind equips with a lift cord 314 for moving the end piece up and down. Since we already have device 305 functions as generic lift cord for all window coverings, item 314 is in the display just for higher simulation fidelity. Similarly, the wand tilter 315 is in the display for the same purpose since it's function has been implemented by device 306.

Although the invention has been illustrated with some particular embodiments, variations and modifications within the scope of the invention are very possible. Fidelity of simulation will also vary with the graphics of the window coverings. Whatever the variation is, it will achieve the goal of present invention—a method and apparatus to simulate an outdoor scene visible window for a windowless room, with a plurality of different types, different styles and different colors of operable simulated window coverings to choose from. In addition, the display monitor can be used for other purpose such as displaying DVD movies. Present invention is not only a multi-purpose device, but also a good decoration item for a windowless room. Hopefully, some employees work in big building will prefer windowless room equipped with outdoor window simulation system by present invention which offers many variations of window coverings and different views decided by location of video cameras over the room with real outdoor window because real window equipped with fixed style window covering and can only see the view immediate outside the window.

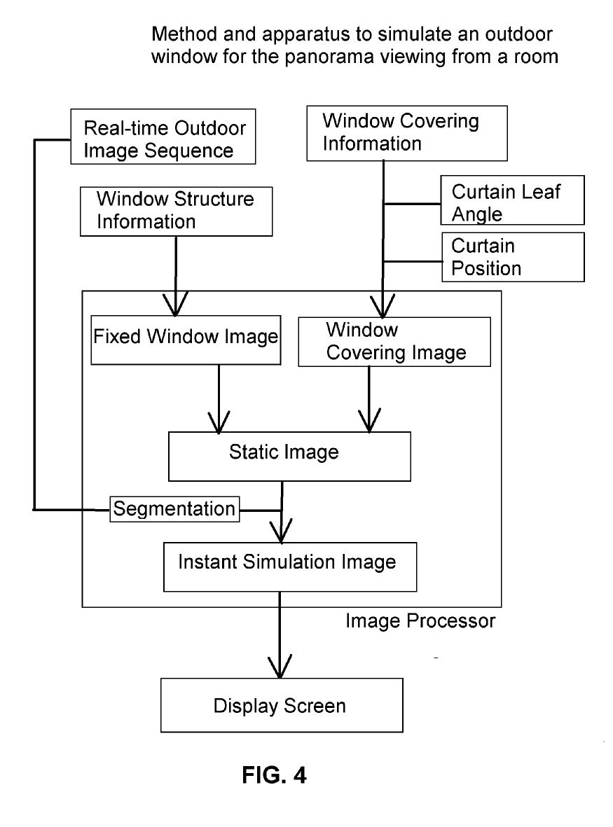

FIG. 4 shows the block diagram regarding to image process performed in current invention. For SWPWRC, only window structure information is required to create display images. SWPWAC, however, requires window covering information for the operable window covering image because it does not equip with real window covering. Note that a segmentation process is required based on human motion detected by the motion detector for extracting portion of the outdoor images and will be discussed more detail in later paragraphs.

FIG. 5 shows a viewer 502 standing in front of a monitor 500, installed at a height 510 above the ground, is used as a display screen in current invention. In order to simplify the discussion following this paragraph, the curtain image is not shown in the screen. A ground area 509 inside which the movement of the viewer can be detected and recorded as point P, with Pₓ and P_{y} as the two coordinate components. One can experience to find that when he moves forward to a real outdoor window, he will see bigger and bigger portion of the outside scene as he approaches closer to the window and vice versa when he moves away from the window. Similarly, he will see more left portion of the scene if he moves rightward and conversely he will see more right portion of the outside scene if he moves leftward. There are two ways are used to simulate this effect. First, a remotely controllable motor-driven video camera can be used to aim at different directions of the outside view, in response to the change in coordinate P detected by the motion detector 501. The control mechanism can be programmed in such a way that the camera zoom will response to viewer's backward-forward motion and change the aim to left or right respectively in response to viewer's rightward or leftward movement. Second, if a remotely controllable video camera is not used, then we can rely on a high resolution, wide angle and still video camera to provide the sequence of outdoor scene images, performing segmentation or digital zoom to each frame of the outdoor scene images according to the movement of point P of the viewer detected by the motion detector. In present invention, digital video cameras in local connections can be remotely controllable based on the information fed from movement of the viewer, but it not possible to do the same for cameras in network connections because many simulation units may have viewers displaying the outdoor scene images come from same digital video camera at same time.

Also shown in FIG. 5 is a possible scope 503 referring to outside scene covered either by the high resolution, wide angle and still video camera or by the motor-driven controllable one. If 403 represents the area of a frame in the sequence of outdoor scene images come from the still video camera, then area 504 can be defined as a default area in the frame from which a default outdoor scene will be displayed on the monitor, either as a beginning display or as a display when no human movement can be detected. However, when a human motion is detected inside the area 509, the segmentation scheme should immediately use the coordinate point P as newest information for segmentation. Depending on location of point P, the segmentation scheme can perform digital zoom to cover area 505 if the viewer move forward closer to the monitor and area 506 conversely if he move backward. Similarly, the area 507 will be covered if the viewer moves rightward such that point P is in the right hand side of area 503, vice versa if point is in the left hand side for area 508 to be covered. The scope area 503 can also represent the scope limit imposed by the motor driven video camera, inside which changing of zooms and directions of sight can result in covering of different areas such as those indicated by 504 through 508. While present invention has been shown, described and illustrated in detail for illustrative purpose, it should be understood by those skilled in the art that equivalent changes in from and detail may be made therein without departing from the true spirit and scope of the invention as disclosed in the accompanying claims.

1. A method for displaying quasi-live panoramic views from multiple locations in multiple windowless rooms comprising the steps of:
installing digital video cameras at each of various panorama view locations;
transmitting panoramic views captured from said digital video cameras as sequences of outdoor scene images into panorama view channel selectors through local connections or network connections;
combining each of said panorama view channel selectors with flat display monitors as panorama simulation windows for displaying panoramic views;
creating fixed window image for each of said panorama simulation windows based on user preferred window style/type upon request by the user;
detecting new position of human motion of a person closest to motion detector installed in each of said windowless rooms;
creating sequences of partial outdoor scene images by segmenting each frame of said sequences of outdoor scene images based on said new position;
creating simulation window paired with real curtain (SWPWRC) by coupling each of said panorama simulation windows with a real window covering, or creating simulation window paired with artificial curtain (SWPWAC) by using operable artificial window covering for each of said panorama simulation windows;
mounting SWPWRC or SWPWAC in windowless rooms;
selecting a channel showing the specific view of interest from each of said panorama view channel selectors;
updating said SWPWRC or SWPWAC display in response to change in said partial outdoor images as a consequence of the human movement detected by said motion detector;
updating said SWPWRC or SWPWAC display in response to change in window style/type upon user's request;
updating said SWPWAC display in response to change in window covering style/type upon user's request; and
updating said SWPWRC or SWPWAC display in response to change in panoramic view through said panorama view channel selectors.

2. The method according to claim 1, wherein the step of creating fixed window image further comprising the steps of:
analyzing structure of outdoor windows of at least two different styles for storing window data representing said outdoor windows in a memory device, said data is characterized by window parameters, which include enumerated values of, but not limited to grid numbers, color of frame, frame styles and sizes of said outdoor windows; and
user controllable constructing/reconstructing of fixed window image based on preferable outdoor window represented by a specific set of data in said window parameters stored in said memory device.

3. The method according to claim 1, wherein the step of creating SWPWRC further comprising the steps of:
superimposing said fixed window image to each frame of said sequences of partial outdoor scene images to form sequences of instant simulation images;
mounting each of said panorama simulation windows on the walls of rooms, especially windowless ones intended for obtaining panorama views from various locations;
mounting a window covering of choice on each of said panorama simulation windows on the walls;
linking controllable real window covering to each of said panorama simulation windows for operating together in synchronous manner; and
displaying sequences of instant simulation images.

4. The method according to claim 1, wherein the step of creating SWPWAC further comprising the steps of:
analyzing structure of window coverings of at least two different styles for storing window covering data representing said window coverings in a memory device, said window covering data is characterized by pleat image tokens together with end pleat position(s) representing window covering opened at various pleat covering ratios, leaf image tokens representing leaves at various openness angles together with various end leaf positions(s) representing various leaf covering ratios, and by window covering parameters, which include numerated values of, but not limited to types, styles, colors, sizes, pleat numbers and leaf numbers of said window coverings;
user controllable constructing/reconstructing of curtain image for chosen window covering opened with user's desired covering ratio from said window covering data stored in said memory device;
superimposing said curtain image on said fixed window image to form a static image;
combining each frame of said sequences of partial outdoor scene images with said static image to form sequences of instant simulation images; and
displaying each of said sequences of instant simulation images in said panorama simulation windows.

5. The method according to claim 4, wherein said window coverings are classified into:
leaf window coverings characterized as having leaves, wherein the controlling operation changes the openness angles of leaves and end leaf position(s), said leaf window coverings include, but not limited to horizontal blinds, vertical blinds; and
pleat window coverings characterized as having pleats, but no leaves, wherein the controlling operation expands/retreats all pleats and moves end pleat(s) to new position(s), said pleat window coverings include, but not limited to shades, curtains of different styles, valance and drape combination and window panels.

6. The method according to claim 4, wherein an image processor, coupled to said memory device, is used as a device for creating and reconstruction of said fixed window image, said curtain image, said static image, said sequences of partial outdoor scene images and said sequences of instant simulation images.

7. The method according to claim 6, wherein a first user interface device, coupled to said image processor, is used as means for interactively selecting/reselecting of window of user's preference, causing construction or reconstruction of said fixed window image and for interactively making selection/reselection of window covering of user's preference, causing construction or reconstruction of said curtain image.

8. The method according to claim 6, wherein a second user interface device, coupled to said image processor, is used as means for changing interactively the openness angle of leaves to new openness angle for window covering in display, consequently forcing reconstruction of new sequence of instant simulation images.

9. The method according to claim 6, wherein a third user interface device, coupled to said image processor, is used as means for moving interactively the end leaf position(s) or end pleat position(s) for different covering ratio for window covering in display, consequently forcing reconstruction of new sequence of instant simulation images.

10. The method according to claim 1, wherein each of said local connections transmits one sequence of said sequences of outdoor scene images from a signal transmitter associated with each of said digital video cameras directly to each of said panorama view channel selectors with wire or wirelessly.

11. The method according to claim 1, wherein network connections transmitting panoramic views through the steps of:
transmitting each of said sequences of outdoor scene images with wire or wirelessly from said signal transmitter associated with each of said digital video cameras to a outdoor scene provider;
uploading said sequences of outdoor scene images from said outdoor scene provider into Internet or other networks for downloading into a panoramic view server; and
distributing said sequences of outdoor scene images from said panoramic view server upon the request from said panorama view channel selectors.

12. The method according to claim 1, wherein said motion detector is mounted on the rim of said flat monitor or mounted on the wall close to said flat monitor for detecting human movement in front of said flat monitor.

13. The method according to claim 1, wherein said quasi-live panorama is a live panorama delayed by not more than 10 minutes.

14. An artificial panorama viewing system for displaying quasi-live panoramic views from multiple locations in multiple windowless rooms comprising:
digital video cameras and acoustic sensors installed at each of various locations of interest for taking sequences of outdoor scene images;
signal transmitters associated with each of said digital video cameras and acoustic sensors for transmitting said sequences of outdoor scene images and sequences of background sound;
panorama view channel selectors for receiving said sequences of outdoor scene images and sequences of background sound transmitted through local connections or network connections from said signal transmitters;
outdoor scene providers for uploading said sequences of outdoor scene images and sequences of background sound to Internet or other networks;
one or more panoramic view servers for collecting said sequences of outdoor scene images and sequences of background sound from outdoor scene providers and distributing to said panorama view channel selectors upon request;
simulation windows paired with real curtains (SWPWRC) for displaying panoramic views transmitted from said panoramic view servers, each of SWPWRC comprising one unit of said panorama view channel selectors, one or more flat display monitors mountable on the wall and a complete set of window covering operable in synchronous manner with operation of said display monitors;
a speaker installed in each of SWPWRC for playing said sequences of background sound;
simulation windows paired with artificial curtains (SWPWAC) for displaying panoramic views transmitted from said panoramic view servers, each of SWPWAC comprising one unit of said panorama view channel selectors, one or more flat display monitors mountable on the wall and a collection of replaceable artificial window coverings functional in blinding or shading at various ratios as a real window covering;
a speaker installed in each of SWPWAC for playing said sequences of background sound;
a memory device in each of said SWPWRC and said SWPWAC for storing window structure information of at least two different types, and said memory device in each of said SWPWAC also storing window covering information of at least two different types;
a first user interface device in each of said SWPWRC for selecting window type/style of user's choice from said memory device;
a first user interface device in each of said SWPWAC for selecting window type/style and window covering type/style of user's choice from said memory device;
a second user interface device in each of said SWPWAC for the control operation of moving end leaf position(s) or end pleat position(s);
a third user interface device in each of said SWPWAC for the control operation of changing leaf openness angle(s);
a motion detector associated with each of said SWPWRC and said SWPWAC for detecting new positions of due to motion of a person closest to said motion detector, sequences of partial outdoor scene images are consequently segmented from said sequences of partial outdoor scene images based on said new positions;
an image processor, further comprised in each of said SWPWRC, connected in between said panorama view channel selectors and said flat display monitors, coupled to said first user interface and said motion detector for construction/reconstruction of sequences of instant simulation images and displaying in said SWPWRC;
an image processor, further comprised in each of said SWPWAC, connected in between said panorama view channel selectors and said flat display monitors, coupled to said first user interface, said second user interface, said third user interface and said motion detector for construction/reconstruction of sequences of instant simulation images and displaying in said SWPWAC; and
a switch device coupled to each of said flat display monitors for selecting other modes of non-simulation applications as television display, computer monitor, DVD display monitor, or any combination thereof.

15. The system according to claim 14, wherein each of said local connections transmits one sequence of said sequences of outdoor scene images from a signal transmitter associated with each of said digital video cameras directly to each of said panorama view channel selectors with wire or wirelessly.

16. The system according to claim 14, wherein network connections transmitting each of said sequences of outdoor scene images with wire or wirelessly from said signal transmitter to a outdoor scene provider, uploading said sequences of outdoor scene images from said outdoor scene provider into Internet or other data networks for downloading into at least one panoramic view server, and distributing said sequences of outdoor scene images from said panoramic view server(s) upon the request from each of said panorama view channel selectors.

17. The system according to claim 14, wherein said flat display monitors include monitors equipped with TV tuner and control circuit to receive and display television programs.

18. The system according to claim 14, wherein said quasi-live panorama is a live panorama delayed by not more than 10 minutes.

19. A panorama simulating apparatus combination for displaying quasi-live panoramic views from multiple locations in multiple windowless rooms comprising:
digital video cameras and acoustic sensors installed at each of various locations of interest for taking sequences of outdoor scene images and sequences of background sound;
signal transmitters associated with each of said digital video cameras and acoustic sensors for transmitting said sequences of outdoor scene images and sequences of background sound;
panorama view channel selectors for receiving said sequences of outdoor scene images and sequences of background sound transmitted through local connections or network connections from said signal transmitters;
outdoor scene providers for uploading said sequences of outdoor scene images and sequences of background sound to Internet or other data networks;
one or more panoramic view servers for collecting said sequences of outdoor scene images and sequences of background sound from outdoor scene providers and distributing to said panorama view channel selectors upon request;
simulation windows paired with real curtains (SWPWRC) for displaying panoramic views transmitted from said panoramic view servers, each of SWPWRC comprising one unit of said panorama view channel selectors, one or more flat display monitors mountable on the wall and a complete set of window covering operable in synchronous manner with operation of said display monitors;
a speaker installed in each of SWPWRC for playing said sequences of background sound;
simulation windows paired with artificial curtains (SWPWAC) for displaying panoramic views transmitted from said panoramic view servers, each of SWPWAC comprising one unit of said panorama view channel selectors, one or more flat display monitors mountable on the wall and a collection of replaceable artificial window coverings functional in blinding or shading at various ratios as a real window covering;
a speaker installed in each of SWPWAC for playing said sequences of background sound;
a memory device in each of said SWPWRC and said SWPWAC for storing window structure information of at least two different types, and said memory device in each of said SWPWAC also storing window covering information of at least two different types;
a first user interface device in each of said SWPWRC for selecting window type/style of user's choice from said memory device;
a first user interface device in each of said SWPWAC for selecting window type/style and window covering type/style of user's choice from said memory device;
a second user interface device in each of said SWPWAC for the control operation of moving end leaf position(s) or end pleat position(s);
a third user interface device in each of said SWPWAC for the control operation of changing leaf openness angle(s);
an image processor, further comprised in each of said SWPWRC, connected in between said panorama view channel selectors and said flat display monitors, coupled to said first user interface for construction/reconstruction of sequences of instant simulation images and displaying in said SWPWRC;
an image processor, further comprised in each of said SWPWAC, connected in between said panorama view channel selectors and said flat display monitors, coupled to said first user interface, said second user interface and said third user interface for construction/reconstruction of sequences of instant simulation images and displaying in said SWPWAC; and
a switch device coupled to each of said flat display monitors for selecting other modes of non-simulation applications as television display, computer monitor, DVD display monitor, or any combination thereof.
